(19) United States
(12) Patent Application Publication
(10) Pub. No.: US 2013/0254152 A1
(43) Pub. Date: Sep. 26, 2013

(54) DISTRIBUTED SYSTEM AND METHODS FOR MODELING POPULATION-CENTRIC ACTIVITIES

(71) Applicants: Rui Zhang, San Francisco, CA (US); Maurice Kyojin Chu, Burlingame, CA (US); Kurt E. Partridge, Palo Alto, CA (US); James M. A. Begole, Los Altos, CA (US)

(72) Inventors: Rui Zhang, San Francisco, CA (US); Maurice Kyojin Chu, Burlingame, CA (US); Kurt E. Partridge, Palo Alto, CA (US); James M. A. Begole, Los Altos, CA (US)

(73) Assignee: PALO ALTO RESEARCH CENTER INCORPORATED, Palo Alto, CA (US)

(21) Appl. No.: 13/429,139

(22) Filed: Mar. 23, 2012

(51) Int. Cl. G06N 5/02; G06F 15/16

(52) U.S. Cl. 706/52; 706/46; 709/217

(57) ABSTRACT

A client device can receive information about a population to which a user belongs. During operation, the client device determines information about a user, determines a group identifier for the user, and communicates the determined information about the local user and the group identifier to a group-modeling server. The client device then receives a group-activity model that corresponds to the group identifier, and generates a user-activity model for the local user based on the group-activity model and the determined information about the local user. The client device uses the user-activity model to compute an activity probability for a corresponding target activity. The group-modeling server receives user information from a plurality of client devices of a group, and generates a group-activity model for the group based on the user information. The server then sends the group-activity model to users of the identified group.

### RELATED APPLICATION

The subject matter of this application is related to the subject matter of the following applications:
U.S. patent application Ser. No. 13/402,751 (Attorney Docket No. PARC-20120035-US-NP), entitled “AUTOMATICALLY TRIGGERING PREDICTIONS IN RECOMMENDATION SYSTEMS BASED ON AN ACTIVITY-PROBABILITY THRESHOLD,” by inventors Rui Zhang, Kurt E. Partridge, Robert R. Price, James M. A. Begole, and Maurice K. Chu, filed ______;
U.S. patent application Ser. No. 13/403,129 (Attorney Docket No. PARC-20120036-US-NP), entitled “A PERFORMANCE-EFFICIENT SYSTEM FOR PREDICTING USER ACTIVITIES BASED ON TIME-RELATED FEATURES,” by inventors Rui Zhang, Kurt E. Partridge, James M. A. Begole, and Robert R. Price, filed ______; and
U.S. patent application Ser. No. ______ (Attorney Docket No. PARC-20120067-US-NP), entitled “A PRIVACY-PRESERVING SYSTEM AND METHOD FOR SAMPLING USERS FOR POPULATION-CENTRIC ACTIVITY MODELING,” by inventors Rui Zhang, Richard Chow, Maurice K. Chu, and Kurt E. partridge, filed ______;
   the disclosures of which are incorporated by reference in their entirety herein.

### BACKGROUND

1. Field

This disclosure is generally related to activity-based recommender systems. More specifically, this disclosure is related to combining activity-prediction models from individual users to generate an activity-prediction model for a population of users.

2. Related Art

Advances in mobile computing have allowed people to consume digital information at any place and any time. It is common for laptops to boast a sufficiently long battery life to allow a user to complete a near full day of work on a single charge. If the user needs an Internet connection, the user is oftentimes able to find a public Wi-Fi hot spot at a local coffee shop or a public venue such as a park. As another example, the capabilities of smartphones have increased drastically to rival the computing abilities of laptops, while also providing steady access to the Internet through a cellular network. These advances have allowed users to perform their computing tasks at a coffee shop, on a park bench, or virtually anywhere. Oftentimes, a user may take his mobile phone out from his pocket for brief moments at a time to play a quick game while riding in a bus, to read the news while waiting in line at a store, or to search for information as necessary.

However, this mobile nature of modern computing has made it difficult to provide targeted recommendations to a user. Previous recommender systems expected a user to be using a computer at home or at work, with an open mind to consider recommendations. A modern computer user is constantly on the go, and may look at his mobile device for short periods at a time. The user may accept a recommendation if it matches his current activity, and may ignore a recommendation that isn't appealing or convenient considering his current activity.

For example, a typical recommender system on a Web service may analyze behavior patterns for many individual users to make a recommendation that is targeted to a certain user. The recommender system may group multiple users that have a similar behavior pattern into a group, and may recommend a product or a service to an individual user based on purchases made by other users in his group. One example of this recommender system includes the movie recommendation system used by Netflix, Inc. to recommend movies to a viewer based on the movie ratings of other similar users. Another example is the product recommendation system used by Amazon, Inc. to recommend products to the user as the user browses Amazon's online catalog.

However, to be effective, these recommender systems need to store and process a history of detailed information about these users' behavior. To make a recommendation, the system needs to know what the user is doing, such as which merchandise items the user is browsing. If the system does not know the user's current activity, the system will have to analyze the information that it does have about the user, in real-time, to predict which activity the user may be performing. Unfortunately, analyzing the user's information can be a computationally expensive operation for a server computer, which can prevent the recommender system from generating a meaningful recommendation in real-time.

### SUMMARY

One embodiment provides a user-activity modeling system that determines an activity probability for a user based on information that it receives about a user population. During operation, the system determines information about a user, determines a group identifier for the user, and communicates the information about the local user and the group identifier to a group-modeling server. The system then receives a group-activity model that corresponds to the group identifier, and generates a user-activity model for the local user based on the group-activity model and the determined information about the local user.

In some embodiments, the system computes a probability that the local user is performing a target activity based on the group-activity model.

In some embodiments, the group-activity model includes a set of group-parameter distributions for the identified group:

N₀(A,σ₀),N₁(B₁,σ₁), . . . Nₙ(Bₙ,σₙ).

In the group-parameter distributions, Nᵢ corresponds to a normal distribution for a corresponding curve-fitting parameter for users of the identified group. The values A and Bᵢ correspond to average values for the corresponding curve-fitting parameters, and σᵢ corresponds to a standard deviation for a corresponding curve-fitting parameter.

In some embodiments, while generating the user-activity model, the system determines a first set of curve-fitting parameters for the local user based on the determined information about the local user, and determines a second set of curve-fitting parameters for the local user based on the first set of curve-fitting parameters and the set of group-parameter distributions. The system then generates a function for the user-activity model. The function can have the form:

p=logit(a+b₁*x₁+b₂*x₂+ . . . +bₙ*xₙ).

The variable xᵢ corresponds to a context feature value, and the coefficients a and bᵢ correspond to curve-fitting parameters. The value p specifies a probability that the contextual information corresponds to a target activity.

In some embodiments, while determining the information about the local user, the system selects at least one of: a subset of contextual information of the local user; a subset of profile information about the local user; a subset of historical activities performed by the local user; and a stored user-activity model for the local user.

In some embodiments, the group identifier corresponds to at least one of: a group of people in the user's online social network; a group of people in the user's contact list stored in the computing device; a group of people whose historical activities are determined to be similar to the user's historical activities; the user's postal area code; the user's current geographic location; and an organization to which the user is affiliated with.

In some embodiments, the contextual information includes at least one of: a geographic location; a motion trajectory; a date range; a logical name associated with a geographic location; a logical name associated with an activity description; a list of participants of the historical activity; and a set of keywords associated with the historical activity.

One embodiment provides a population-modeling system that generates a group-activity model for users of a population group. During operation, the system receives a group identifier and information about a user from the user's client device, such that the group identifier identifies a group of similar users. The system generates a group-activity model for the identified group based on information from users in the identified group, and communicates the group-activity model to one or more client devices that correspond to users of the identified group.

In some embodiments, the system communicates the group-activity model in response to determining that the computed group-activity model is sufficiently different from a previous group-activity model.

In some embodiments, while generating the group-activity model, the system selects information from a plurality of users of the identified group, and generates the group-activity model based on the selected information. To generate the group-activity model, system then generates a set of group-parameter distributions:

N₀(A,σ₀),N₁(B₁,σ₁), . . . Nₙ(Bₙ,σₙ).

In the set of group-parameter distributions, Nᵢ corresponds to a normal distribution for a corresponding curve-fitting parameter for users of the identified group. The values A and Bᵢ correspond to average values for the corresponding curve-fitting parameters, and σᵢ corresponds to a standard deviation for a corresponding curve-fitting parameter.

### BRIEF DESCRIPTION OF THE FIGURES

FIG. 1 illustrates an exemplary computing environment in accordance with an embodiment.

FIG. 2 illustrates an exemplary communication between client devices and a population-modeling server in accordance with an embodiment.

FIG. 3 presents a flow chart illustrating a method for generating a recommendation based on a group-activity model in accordance with an embodiment.

FIG. 4 presents a flow chart illustrating a method for sending user information to a population-modeling server in accordance with an embodiment.

FIG. 5 presents a flow chart illustrating a method for generating a user-activity model for the local user in accordance with an embodiment.

FIG. 6 presents a flow chart illustrating a method for distributing a group-activity model in accordance with an embodiment.

FIG. 7 presents a flow chart illustrating a method for generating a group-activity model for a user population in accordance with an embodiment.

FIG. 8 illustrates an exemplary apparatus that facilitates generating a group-activity model for a user population in accordance with an embodiment.

FIG. 9 illustrates an exemplary computer system that facilitates generating a group-activity model for a user population in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide an activity-modeling system that solves the problem of efficiently determining, at the user's client device, an activity that the user may be performing based on information gathered from other users in a community. For example, the user's client device may not always have enough historical activity information for the local user to predict whether the local user is performing a certain activity, and may need to leverage information obtained from other similar users to make the prediction. The user's client device can receive a group-activity model from a central system, and can use this group-activity model to determine a probability that the user is currently performing a certain activity.

Individuals within a population group oftentimes have behavior patterns that are similar to other users in their population group. People within a geographic region, for example, are likely to be loyal fans of a local sports team, and so they may be likely to watch a championship game either at home or with friends when their local team is playing in the championship game. As another example, members of a social club or people that are mutual “friends” on an online social network may have similar activity interests, and may be likely to perform a certain activity when facing certain specific conditions. These group members may be interested in purchasing similar types of merchandise while shopping, or they may be interested in performing similar types of activities during the weekend.

During operation, the user's client device can use the user's contextual information to generate information about the user, such as aggregated behavior data or an activity model that represents the user's behavior. The client device can send the information about the user to the central system that combines information obtained from multiple users of a given group. The user's client device also receives a population-centric activity model (hereinafter also referred to as the group-activity model), which represents the conditions under which the users in the population group may perform a certain target activity. The user's client device uses the group-activity model to generate a user-centric activity model (hereinafter also referred to as a user-activity model) for the user.

The client device can user the user-activity model to analyze the user's behavior. The client device can, for example, use the user-activity model to predict whether the local user is performing the target activity. As another example, the client device can use the user-activity model to classify the user's behavior to determine whether the user is behaving normally or abnormally relative to the user's previous behavior pattern, or relative to the behavior patterns of other users in the user's population. Further, in response to the user performing a certain activity, the client device (or the population-modeling server) can use the user-activity model or the group-activity model to determine why the user may have decided to perform or otherwise participate in the activity.

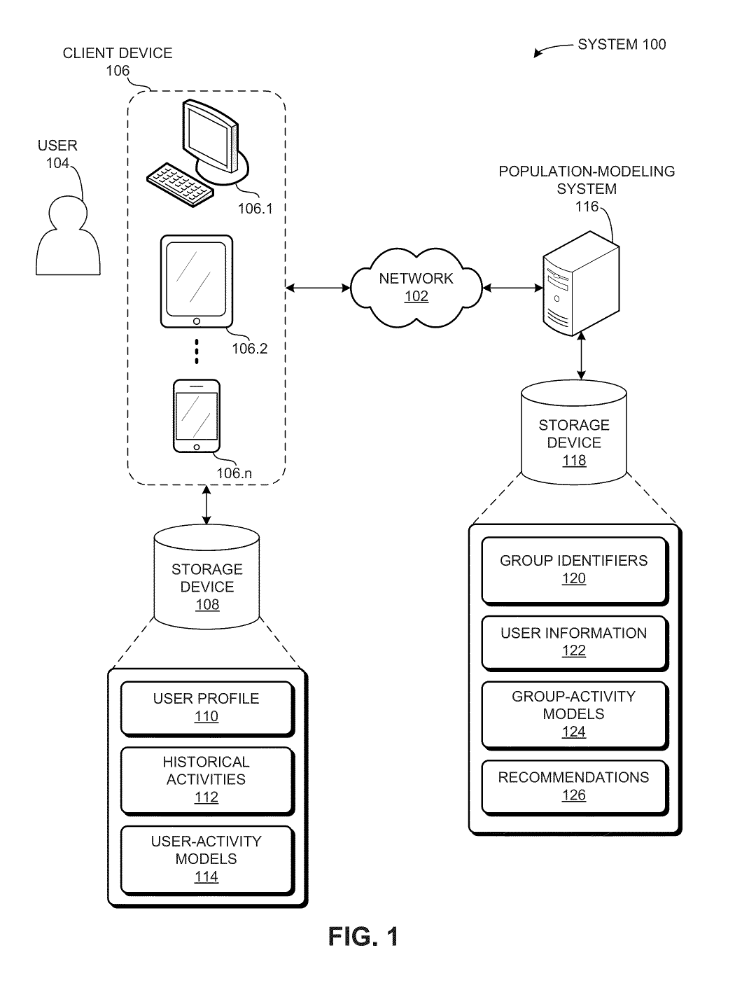

FIG. 1 illustrates an exemplary computing environment 100 in accordance with an embodiment. Computing environment 100 can include network 102, a client device 106, and a population-modeling system 116. Computing device 106 can include any personal computing device that gathers contextual information for a user 104. For example, computing device 106 can include a personal computer 106.1, a tablet computer 106.2, a smartphone 106.n, or any other computing device such as a laptop, an internet-enabled television, etc. Client device 106 can be coupled to a storage device 108, which can store at least a user profile 110, historical activities 112, and user-activity models 114 for user 104.

During operation, client device 106 can monitor the behavior and activities of user 104 to generate contextual information 112. A historical activity can include a snapshot of contextual information about user 104 for a period of time before the user performs a certain activity and/or while the user is performing the activity. The historical activity can also include a deterministic activity indicator that client device 106 can use to determine the activity that was performed by user 104. The deterministic activity indicator can include, for example, a geographic location and/or an activity that user 104 performs at the geographic location (e.g., jogging at Central Park), a name of a store, a name of an event, etc. The contextual information can include a geographic location, a motion trajectory, a time range, a logical name associated with a geographic location, Email/short messaging service (SMS) messages, audio recordings, shows or movies viewed by user 104, web page views, and any other information that is gathered about the behavior and activities of user 104.

Client device 106 can use historical activities 112 to generate aggregated data for user 104, and sends information about user 104 (e.g., the aggregated data, historical activities 112, and/or a group identifier) to population-modeling system 116. Client device 106 can also receive group-activity models that population-modeling system 116 generates for a population of users to which user 104 belongs, and uses these group-activity models to generate user-activity models for user 104. Client device 106 can use these user-activity models to predict the behavior of user 104 and to generate a recommendation (e.g., an advertisement or a coupon) that is targeted to the user's current activity.

Population-modeling system 116 can also include any computing device or group of computing devices coupled to network 102. Population-modeling system 116 can be coupled to a storage device 118, which can store at least group identifiers 120 for users, user-activity models 122, group-activity models 124, and product recommendations 126. Population-modeling system 116 can receive group identifiers 120 and user information from a plurality of users, and stores the received user information in association to their corresponding group identifiers.

Group identifiers 120 can identify any population group that user 104 is affiliated with or be similar to in some way. For example, a population group can include other users within a geographic region (e.g., a city, a state, a country, etc.) or a group of friends in an on-line social network. The population group can also include a group of people that are affiliated with a certain organization, such as a company, a volunteer group, a political party, etc. Further, a population group can include any group that user 104 is assigned to, such as a group of other users that have been determined to have similar behavior patterns to user 104, regardless of whether user 104 is directly affiliated with these other users or not.

To generate a group-activity model, population-modeling system 116 uses group identifiers 120 to select user information that corresponds to various users in a certain group, and generates a group-activity model based on the selected user information. These group-activity models can be used to process contextual information from user 104 to determine which activities user 104 may be performing.

Population-modeling system 116 can include a plurality of recommendations, such that each recommendation is associated with certain contextual information for a target activity. When population-modeling system 116 sends a group-activity model to client device 106, population modeling system 116 can also send one or more recommendations associated with the target activity to client device 106. Client device 106 can present a recommendation to user 104 when it determines that user 104 is performing a corresponding target activity.

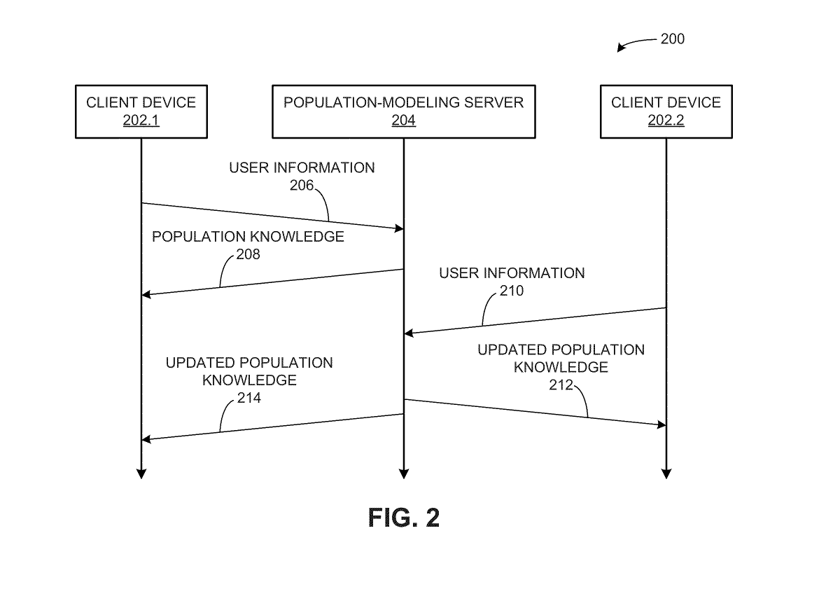

FIG. 2 illustrates an exemplary communication 200 between client devices 202 and a population-modeling server 204 in accordance with an embodiment. During operation, population-modeling server 204 can receive user information 206 from a client device 202.1. User information 206 can include a a group identifier as well as profile and behavior data for a user of client device 202.1. The behavior data, for example, can also include contextual information about the user of client device 202.1, such as raw contextual information or aggregated contextual information. The raw contextual information can include geolocation data, audio and/or video content, text, and any other information obtained from the user. The aggregated contextual information can include statistical information derived from the raw contextual information for a certain time window.

Population-modeling server 204 can use user information 206 to generate or update population knowledge 208, which can include information about a population group that the user is associated with. Population-modeling server 204 can also send population knowledge 208 to client device 202.1 so that client device can predict the user's behavior using population knowledge 208.

Population-modeling server 204 can also update the population knowledge using information obtained from other users of the population group. For example, population-modeling server 204 can receive user information 210 from a client device 202.2 corresponding to the same population group. Population-modeling server 204 updates the information about the population group to generate updated population knowledge 212, and sends updated population knowledge 212 to client device 202.2.

In some embodiments, population-modeling server 204 can also send any updates to the population knowledge to other client devices whose users are associated with the population group. For example, population-modeling server 204 can determine whether there is a significant change between population knowledge 208 and updated population knowledge 212. If so, population-modeling server 204 can forward the updated population knowledge to the other members of the population group (e.g., by sending updated population knowledge 214 to client device 202.1).

### Client Device

In some embodiments, the user's client device can provide activity information about the user's behavior to a central system, and receives group-activity models that represent the conditions under which the users in the population group may perform certain activities. The client device uses these group-activity models to obtain activity information about other similar users, and to generate user-activity models for the local user. The client device can use these user-activity models to determine which activities the user may be performing, and to make a recommendation to the user.

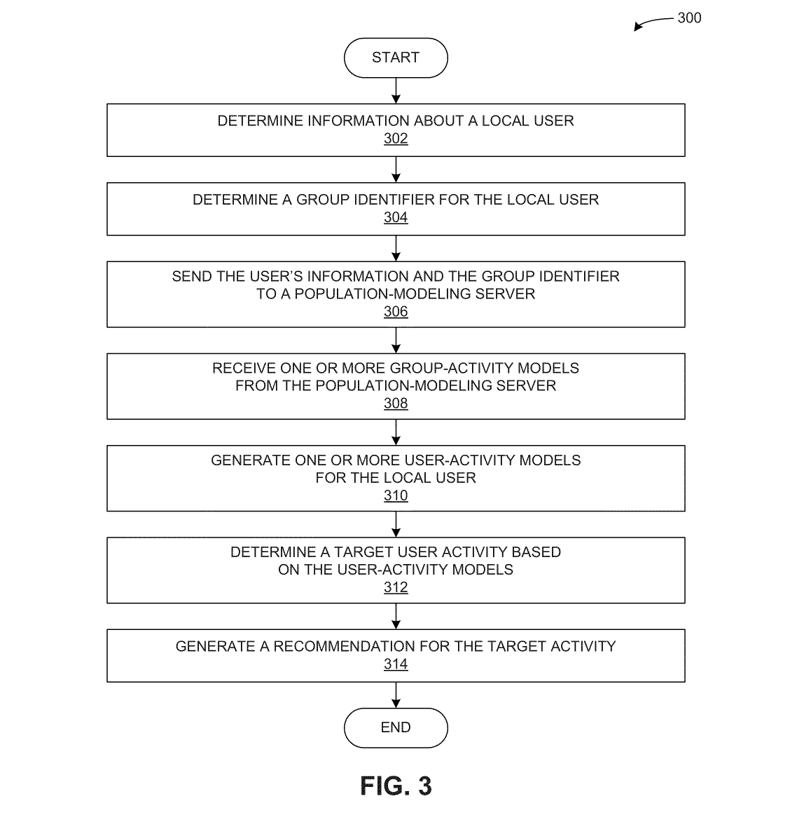

FIG. 3 presents a flow chart illustrating a method 300 for generating a recommendation based on a group-activity model in accordance with an embodiment. During operation, the client device can determine information about a local user (operation 302), determines a group identifier for the local user (operation 304), and sends the information about the local user and the group identifier to a population-modeling server (operation 306). The information about the local user can include previous or current activity information about the user, aggregated activity information that has been compiled to summarize the user's activities, and/or can include information from the user's profile.

The client device then receives one or more group-activity models from the population-modeling server (operation 308), and generates one or more user-activity models for the local user (operation 310). For example, the client device can receive group-activity models for each target activity that is often performed by members of the user's population. These group-activity models are generated using activity information from members of a population group, and the client device uses this information to create the user-activity model so that it is optimized for the local user.

Each group-activity model includes a set of group-parameter distributions for the identified group:

N₀(A,σ₀),N₁(B₁,σ₁), . . . Nₙ(Bₙ,σₙ). (1)

In equation (1), Nᵢ corresponds to a normal distribution for a corresponding curve-fitting parameter of the identified group. The values A and Bᵢ correspond to average values for their corresponding curve-fitting parameters, and σᵢ corresponds to a standard deviation for a corresponding curve-fitting parameter from the group of users.

Each user-activity model can include a function of the form:

p=logit(a+b₁*x₁+b₂*x₂+ . . . +bₙ*xₙ) (2)

In equation (2), the coefficients a and bᵢ correspond to curve-fitting parameters for the local user. The variable a is known as the intercept, and the variables bᵢ are known as the regression coefficients. The value p specifies a probability that the user's contextual information (xᵢ) indicates that the user is performing a corresponding target activity. The variables xᵢ in equation (2) correspond to real-time context feature values from the user that the client device can use to generate the probability p.

The client device analyzes the user-activity models to determine a target activity that the user may be performing (operation 312), and can generate a recommendation that corresponds to the target activity (operation 314).

The user's client device can periodically provide behavior information about the user to the central server. This behavior information can include selective information from the user's activities or the user's profile, and can be filtered based on types of information that the user agrees to share with the population-modeling server.

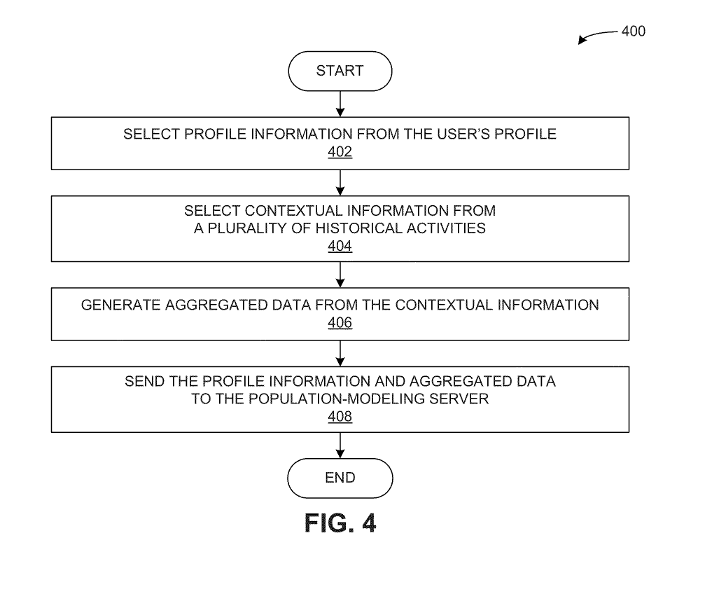

FIG. 4 presents a flow chart illustrating a method 400 for sending user information to a population-modeling server in accordance with an embodiment. During operation, the client device selects profile information from the user's profile (operation 402), and selects contextual information from a plurality of historical activities (operation 404). The client device then generates aggregated data from the contextual information (operation 406), and sends the profile information and aggregated data to the population-modeling server (operation 408). In some embodiments, the aggregated data can include a total number of times that the device has detected a certain context or activity (e.g., the user visiting a certain location), a number of occurrences during a certain time interval (e.g., for a certain month, or during the past month), an average frequency of the occurrences, an average time duration between occurrences, etc.

The aggregated data can also include a statistical distribution for the contextual information or activities detected by the client device. This statistical distribution may indicate the distribution of occurrence frequencies during a given time interval, such as the mean or median number of times that the user has visited a certain location during a week, as well as the standard deviation. This statistical distribution can also indicate a distribution of time intervals for the detected occurrences, such as the mean or median time duration for each detected context or activity, and the standard deviation.

During operation 402, the client device can filter the amount of data that is sent to the population-modeling server by only selecting a portion of the user's contextual information. The client device can select, for example, a subset of the contextual data that was used to generate the aggregated data about the user, or can select the contextual information associated with certain activities. As another example, the client device can select information based on privacy settings set by the user that indicate which types of information the user is willing to share. The privacy settings can be obtained directly from the user, or can be obtained from privacy settings that a user has set within an online social network.

In some embodiments, the user's client device can generate a user-activity model to provide to the population-modeling server, and the population-modeling server combines this user-activity model with user-activity models from other users to generate or update a group-activity model. The client device can generate the user-activity model using the user's historical activities, the aggregated data about the user, and/or a group-activity model. Then, during operation 408, the client device can send this user-activity model to the population-modeling server, which the server can use to generate or update a group-activity model.

In some embodiments, the client device can also generate a user-activity model for the local user using a group-activity model that it has received from the population-modeling server (e.g., during operation 310 of FIG. 3). The client device can generate the user-activity model to tailor the group-activity model for the local user, which can result in more accurate activity predictions for the local user than if the group-activity model was used as-is.

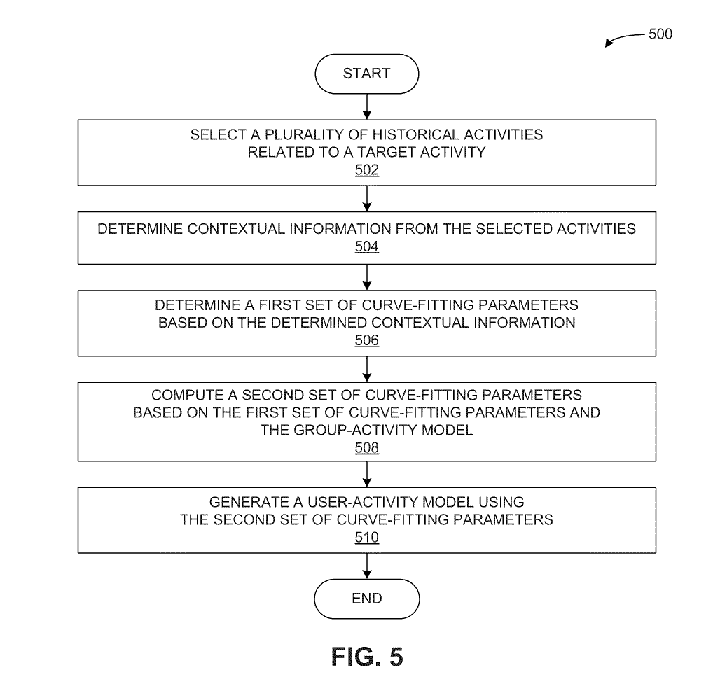

FIG. 5 presents a flow chart illustrating a method 500 for generating a user-activity model for the local user in accordance with an embodiment. During operation, the client device selects a plurality of historical activities that correspond to a target activity (operation 502), for example, by selecting a plurality of historical activities that have a matching deterministic activity indicator. The client device determines contextual information from the selected activities (operation 504), and determines a first set of curve-fitting parameters based on the determined contextual information (operation 506).

The client device also computes a second set of curve-fitting parameters based on the first set of curve-fitting parameters and the group-activity model (operation 508). The client device then generates the user-activity model using the second set of curve-fitting parameters (operation 510). Recall that the user-activity model includes a function that has the form:

p=logit(a+b₁*x₁+b₂*x₂+ . . . +bₙ*xₙ) (3)

The client device can determine the first set of coefficient values (e.g., coefficients a and bᵢ) by processing the contextual features of the user's historical activities. For example, the client device can use the method of least squares, maximum-likelihood estimation, or any other statistical analysis technique now known or later developed.

The client device can determine the second set of coefficient values by combining the coefficients in the first set with coefficients from the group-activity model. For example, the system can determine a weight amount for each coefficient of the group-activity model (e.g., for a parameter Nᵢ of equation (2)), and can compute a weighted average between the first set of coefficient values and the coefficient values of the group-activity model. To determine the weight amount for each parameter of the group-activity model, the system can consider the standard deviation for each of these parameters. For example, the system can compute the weight amounts for each parameter so that parameter values with a low standard deviation have a higher weight than other parameter values that have a higher standard deviation. These weighted values allow the coefficients in the group-activity model that have a lower standard deviation (and thus are more likely to be accurate) to have a higher influence on the user-activity model for the local user than other coefficients with a higher standard deviation.

### Population-Modeling System

The population-modeling system can receive behavior information from a community of users, and can generate a group-activity model for this community. Further, the system can periodically update the group-activity model by receiving updates to the users' behavior information from their devices, and can send the updated group-activity model to the community when the system detects a significant change in behavior from the community.

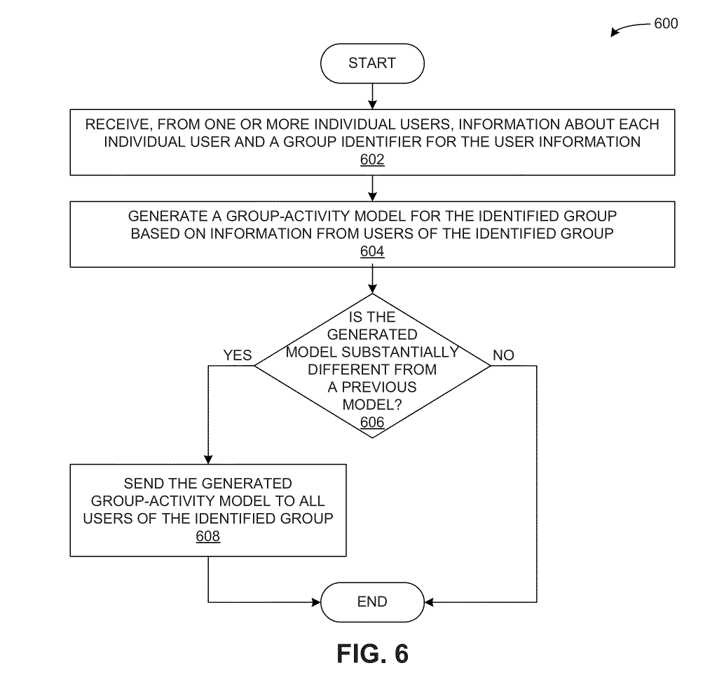

FIG. 6 presents a flow chart illustrating a method 600 for distributing a group-activity model in accordance with an embodiment. During operation, the system can receive, from one or more individual users, information about each individual user and a group identifier for the user information (operation 602). The group identifier can be any piece of information that can be used to match the user with other users, or to select user information for users that belong to a certain population group. For example, the group identifier can be an explicit group identifier that other users have indicated, or can be contextual information that is used to cluster different users together into a group (e.g., a current geographic location). As a further example, the group identifier can be information from the user's profile (e.g., personal interests, a home address, an occupation type, or a place of employment), or can be a social network attribute (e.g., an online screen name or a group name). The group identifier can also be a current or past activity, such as “hiking,” “working,” “grocery shopping,” etc.

The system generates the group-activity model for the identified group using information obtained from users of the identified group (operation 604). If the group-activity model replaces a previous group-activity model that was generated using older user information, the system can distribute the new group-activity model to client devices associated with the identified group.

To distribute the group-activity model, the system determines whether the generated group-activity model is substantially different from the previous group-activity model (operation 606). The system can compare the two models using any technique now known or later developed for determining a similarity between two data sets, such as techniques for computing a Euclidean distance, a Hamming distance, etc. The system can determine whether the two models are sufficiently different by determining whether a computed similarity between the two models is below a determinable threshold.

In some embodiments, the system determines whether the two models are substantially different by determining whether at least a certain number (or percentage) of their parameters are determined to be sufficiently different. For example, the system can compute a percentage by which each of the parameters has changed between the two models (e.g., a change between the curve-fitting parameters and/or their standard deviation), and determines a number of these parameters that are sufficiently different (e.g., have changed by at least a certain threshold). If the generated model and the stored model are sufficiently different, the system sends the generated group-activity model to the client devices for users of the identified group (operation 608).

### Generating a Group-Activity Model

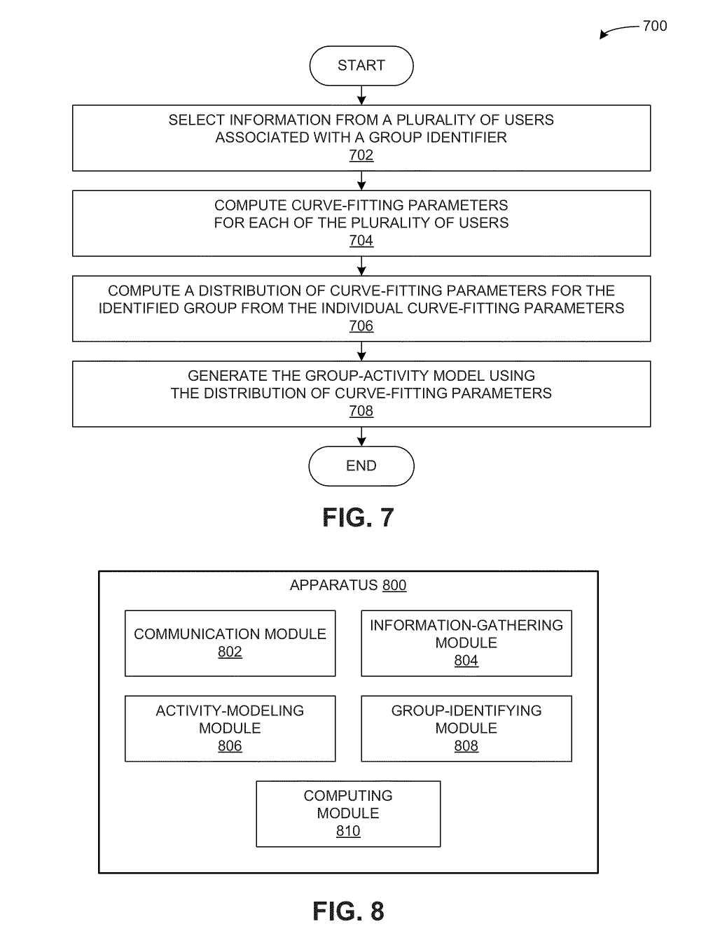

FIG. 7 presents a flow chart illustrating a method 700 for generating a group-activity model for a user population in accordance with an embodiment. During operation, the population-modeling system selects information from a plurality of users associated with a group identifier (operation 702), and computes curve-fitting parameters for each of the plurality of users using the selected information (operation 704). For example, the system can select aggregated data that represents behavior patterns for each user, and generates the curve-fitting parameters for each user that can be used to generate an activity model. In some embodiments, however, the system can receive pre-computed curve-fitting parameters that were computed for individual users by their client devices. The system then computes a distribution of curve-fitting parameters for the identified group from the individual curve-fitting parameters (operation 706).

For example, to compute each of the curve-fitting parameters for the group-activity model, the system can compute the average (or weighted average) for each of the model parameters of the population group. In some embodiments, the system can determine weights for individual users of the population group by computing a utility score or an accuracy score for these users, and uses these weights to compute a weighted value for the curve-fitting parameters. The utility score, for example, can indicate a usefulness of the user's contextual information, which accounts for an information gain amount for the population-centric activity-prediction model and a privacy cost to the user. The accuracy score can indicate a likelihood that the user's activity-prediction model is able to predict its corresponding user's activity (or the activity of any other user in the population group).

The distribution of curve-fitting parameters for the identified group can be represented as follows:

N₀(A,σ₀),N₁(B₁,σ₁), . . . Nₙ(Bₙ,σₙ). (4)

In equation (4), the symbol Nᵢ corresponds to a normal distribution for a corresponding curve-fitting parameter for users of the identified group. The values A and Bᵢ correspond to average values for their corresponding curve-fitting parameters, and σᵢ corresponds to a standard deviation for a corresponding curve-fitting parameter.

FIG. 8 illustrates an exemplary apparatus 800 that facilitates generating an activity-prediction model for a user population in accordance with an embodiment. Apparatus 800 can comprise a plurality of modules which may communicate with one another via a wired or wireless communication channel. Apparatus 800 may be realized using one or more integrated circuits, and may include fewer or more modules than those shown in FIG. 8. Further, apparatus 800 may be integrated in a computer system, or realized as a separate device which is capable of communicating with other computer systems and/or devices. Specifically, apparatus 800 can comprise a communication module 802, a information-gathering module 804, an activity-modeling module 806, a group-identifying module 808, and a computing module 810.

In some embodiments, communication module 802 can send and/or receive user information and/or population knowledge. Information-gathering module 804 can determine information about a user. Group-identifying module 808 can determine a group identifier for the user, and communication module 802 can use the group identifier to obtain group-activity models for the identified group. Activity-modeling module 806 can generate user-activity models for the user based on the group-activity models and the user's contextual information. Computing module 810 can compute a probability for a target user activity based on the user-activity models.

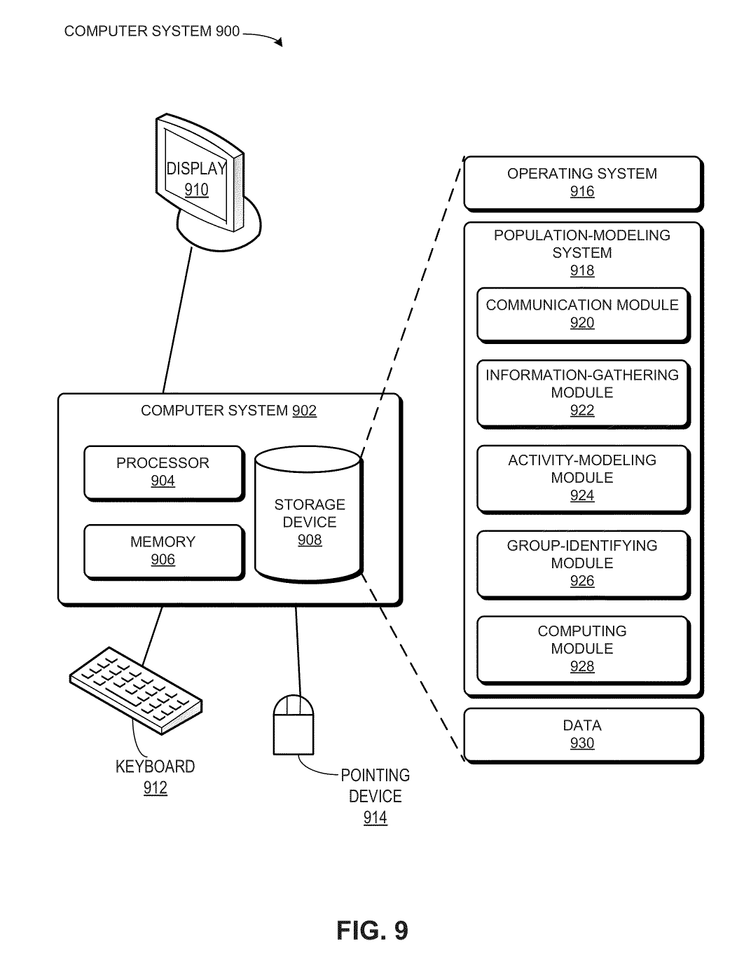

FIG. 9 illustrates an exemplary computer system 902 that facilitates generating an activity-prediction model for a user population in accordance with an embodiment. Computer system 902 includes a processor 904, a memory 906, and a storage device 908. Memory 906 can include a volatile memory (e.g., RAM) that serves as a managed memory, and can be used to store one or more memory pools. Furthermore, computer system 902 can be coupled to a display device 910, a keyboard 912, and a pointing device 914. Storage device 908 can store operating system 916, population-modeling system 918, and data 930.

Population-modeling system 918 can include instructions, which when executed by computer system 902, can cause computer system 902 to perform methods and/or processes described in this disclosure. Specifically, population-modeling system 918 may include instructions for sending and/or receiving user information and/or population knowledge (communication module 920). Further, population-modeling system 918 can include instructions for determining information about a user (information-gathering module 922).

Population-modeling system 918 can also include instructions for determining a group identifier for the user (group-identifying module 926), and obtaining group-activity models for the identified group (communication module 920). Population-modeling system 918 can also include instructions for generating user-activity models for the user based on the group-activity models and the user's contextual information (activity-modeling module 924), and for computing a probability for a target user activity based on the user-activity models (computing module 928).

Data 930 can include any data that is required as input or that is generated as output by the methods and/or processes described in this disclosure. Specifically, data 930 can store at least a user profile, a user's contextual information, a user-centric activity-prediction model, a group identifier, a population-centric activity-prediction model, and a recommendation.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
determining, by a computing device, information about a local user;
determining a group identifier for the local user, wherein the group identifier identifies a group of users to which the local user belongs;
communicating the determined information about the local user and the group identifier to a group-modeling server;
receiving a group-activity model;
generating a user-activity model for the local user based on the group-activity model and the determined information about the local user.

2. The method of claim 1, wherein the user-activity model facilitates computing a probability that the local user is performing a corresponding target activity; and
wherein the method further comprises computing the probability that the local user is performing the target activity based on the user-activity model and the local user's contextual information.

3. The method of claim 1, wherein the group-activity model includes a set of group-parameter distributions for the identified group:
N₀(A,σ₀),N₁(B₁,σ₁), . . . Nₙ(Bₙ,σₙ);
wherein Nᵢ corresponds to a normal distribution for a corresponding curve-fitting parameter for users of the identified group, wherein A and Bᵢ correspond to average values for the corresponding curve-fitting parameters, and wherein σᵢ corresponds to a standard deviation for a corresponding curve-fitting parameter.

4. The method of claim 3, wherein generating the user-activity model involves:
determining a first set of curve-fitting parameters for the local user based on the determined information about the local user;
determining a second set of curve-fitting parameters for the local user based on the first set of curve-fitting parameters and the set of group-parameter distributions; and
generating a function for the user-activity model based on the second set of curve-fitting parameters, wherein the function has the form:
p=logit(a+b₁*x₁+b₂*x₂+ . . . +bₙ*xₙ);
wherein p is a probability that the determined information about the local user corresponds to a target activity, wherein a and bᵢ correspond to curve-fitting parameters, and wherein xᵢ corresponds to a context feature value.

5. The method of claim 1, wherein the group identifier corresponds to at least one of:
a group of people in the local user's online social network;
a group of people in the local user's contact list stored in the computing device;
a group of people whose historical activities are determined to be similar to the local user's historical activities;
the local user's postal area code;
the local user's current geographic location; and
an organization to which the local user is affiliated with.

6. The method of claim 1, wherein determining the information about the local user involves selecting at least one of:
a subset of contextual information of the local user;
a subset of profile information about the local user;
a subset of historical activities performed by the local user; and
a stored user-activity model for the local user.

7. The method of claim 6, wherein the contextual information includes at least one of:
a geographic location;
a motion trajectory;
a date range;
a logical name associated with a geographic location;
a logical name associated with an activity description;
a list of participants of the historical activity; and
a set of keywords associated with the historical activity.

8. A computer-implemented method, comprising:
receiving a group identifier and information about a user from a client device, wherein the group identifier identifies a group of similar users;
generating a group-activity model for the identified group based on a plurality of user-activity models from users in the identified group; and
communicating the group-activity model to one or more client devices that correspond to users of the identified group.

9. The method of claim 8, wherein the method further comprises:
receiving information about the user from the client device;
storing the received information in association with the identified group;
selecting information from a set of users of the identified group; and
generating the group-activity model based on the selected information, wherein generating the group-activity model involves generating a set of group-parameter distributions:
N₀(A,σ₀),N₁(B₁,σ₁), . . . Nₙ(Bₙ,σₙ);
wherein Nᵢ corresponds to a normal distribution for a corresponding curve-fitting parameter for users of the identified group, wherein A and Bᵢ correspond to average values for the corresponding curve-fitting parameters, and wherein σᵢ corresponds to a standard deviation for a corresponding curve-fitting parameter.

10. The method of claim 8, wherein communicating the group-activity model involves:
determining that the computed group-activity model is sufficiently different from a previous group-activity model.

11. An apparatus, comprising:
an information-gathering module to determine information about a local user;
a group-identifying module to determine a group identifier for the local user, wherein the group identifier identifies a group of users to which the local user belongs;
a communication module to:
communicate the determined information about the local user and the group identifier to a group-modeling server; and
receive a group-activity model; and
an activity-modeling module to generate a user-activity model for the local user based on the group-activity model and the determined information about the local user.

12. The apparatus of claim 11, wherein the user-activity model facilitates computing a probability that the local user is performing a corresponding target activity; and
wherein the apparatus further comprises a computing module to compute the probability that the local user is performing the target activity based on the user-activity model and the local user's contextual information.

13. The apparatus of claim 11, wherein the group-activity model includes a set of group-parameter distributions for the identified group:
N₀(A,σ₀),N₁(B₁,σ₁), . . . Nₙ(Bₙ,σₙ);
wherein Nᵢ corresponds to a normal distribution for a corresponding curve-fitting parameter for users of the identified group, wherein A and Bᵢ correspond to average values for the corresponding curve-fitting parameters, and wherein σᵢ corresponds to a standard deviation for a corresponding curve-fitting parameter.

14. The apparatus of claim 13, wherein while generating the user-activity model, the activity-modeling module is further configured to:
determine a first set of curve-fitting parameters for the local user based on the determined information about the local user;
determine a second set of curve-fitting parameters for the local user based on the first set of curve-fitting parameters and the set of group-parameter distributions; and
generate a function for the user-activity model based on the second set of curve-fitting parameters, wherein the function has the form:
p=logit(a+b₁*x₁+b₂*x₂+ . . . +bₙ*xₙ);
wherein p is a probability that the determined information about the local user corresponds to a target activity, wherein a and bᵢ correspond to curve-fitting parameters, and wherein xᵢ corresponds to a context feature value.

15. The apparatus of claim 11, wherein the group identifier corresponds to at least one of:
a group of people in the local user's online social network;
a group of people in the local user's contact list stored in the computing device;
a group of people whose historical activities are determined to be similar to the local user's historical activities;
the local user's postal area code;
the local user's current geographic location; and
an organization to which the local user is affiliated with.

16. The apparatus of claim 11, wherein while determining the information about the local user, the information-gathering module is further configured to select at least one of:
a subset of contextual information of the local user;
a subset of profile information about the local user;
a subset of historical activities performed by the local user; and
a stored user-activity model for the local user.

17. The apparatus of claim 16, wherein the contextual information includes at least one of:
a geographic location;
a motion trajectory;
a date range;
a logical name associated with a geographic location;
a logical name associated with an activity description;
a list of participants of the historical activity; and
a set of keywords associated with the historical activity.

18. A non-transitory computer-readable storage medium storing instructions that when executed by a computer cause the computer to perform a method, the method comprising:
receiving a group identifier and information about a user from a client device, wherein the group identifier identifies a group of similar users;
generating a group-activity model for the identified group based on a plurality of user-activity models from users in the identified group; and
communicating the group-activity model to one or more client devices that correspond to users of the identified group.

19. The storage medium of claim 18, wherein the method further comprises:
receiving information about the user from the client device;
storing the received information in association with the identified group;
selecting information from a set of users of the identified group; and
generating the group-activity model based on the selected information, wherein generating the group-activity model involves generating a set of group-parameter distributions:
N₀(A,σ₀),N₁(B₁,σ₁), . . . Nₙ(Bₙ,σₙ);
wherein Nᵢ corresponds to a normal distribution for a corresponding curve-fitting parameter for users of the identified group, wherein A and Bᵢ correspond to average values for the corresponding curve-fitting parameters, and wherein σᵢ corresponds to a standard deviation for a corresponding curve-fitting parameter.

20. The storage medium of claim 18, wherein communicating the group-activity model involves:
determining that the computed group-activity model is sufficiently different from a previous group-activity model.
